(19) United States
(12) Patent Application Publication
(10) Pub. No.: US 2026/0326114 A1
(43) Pub. Date: Oct. 22, 2026

(54) APPARATUS AND METHOD FOR SECURING AN ACCESS DOOR OF A MINERAL MATERIAL CRUSHER

(71) Applicant: Metso Finland Oy, Espoo (FI)

(72) Inventor: Mohamed Romdhane, Espoo (FI)

(73) Assignee: Metso Finland Oy, Espoo (FI)

(21) Appl. No.: 19/122,060

(22) PCT Filed: Oct. 12, 2023
(86) PCT No.: PCT/FI2023/050582

§ 371 Date: Apr. 17, 2025

(30) Foreign Application Priority Data
Oct. 20, 2022 (FI) 20225951

(51) Int. Cl. B02C 23/04; E05B 13/00; E05B 35/06

(52) U.S. Cl. CPC B02C 23/04; E05B 13/001; E05B 35/06

(57) ABSTRACT

An access door blocking device and a method for securing an access door of a mineral material crusher. The access door blocking device includes a first block configured to block opening of the access door when moved from a first releasing position to a first blocking position. The blocking device also includes a second block configured to block opening of the first block when moved from a second releasing position to a second blocking position.

### TECHNICAL FIELD

The present disclosure generally relates to an access door of a mineral material crusher. The disclosure relates particularly, though not exclusively, to an access door blocking device for securing the access door.

### BACKGROUND

This section illustrates useful background information without admission of any technique described herein representative of the state of the art.

Mineral material crushers are used for crushing mineral, ore, and rock material to smaller sizes. The crushers typically comprise an access door to allow maintenance access to the interior of a crusher. Access doors may be equipped with blocking devices to prevent door opening and entering inside the crusher while the crusher is operating. Further, safety interlocks can be used to automatically stop the crusher in case the access door is opened during operation.

The blocking of access doors is typically secured by using bolts and screws. However, screws and/or bolts may suffer from poor tightening causing unsecure closure of the access door. The screws and/or bolts may also loosen unnoticeably during use due to vibration from the crusher or due to accumulated wear and tear. Further, a possibility remains for a person, such as an operator of a crusher, to open the bolts and/or screws and the access door while parts are moving inside the crusher. Therefore, undesired opening of an access door can still occur. In such cases, potentially slow or failed stoppage of the crusher is dangerous. Accordingly, it is desired to mitigate the chances of an undesired and unsafe opening of an access door during crusher operation.

### SUMMARY

The appended claims define the scope of protection. Any examples and technical descriptions of apparatuses, products and/or methods in the description and/or drawings not covered by the claims are presented not as embodiments of the invention but as background art or examples useful for understanding the invention.

According to a first example aspect there is provided an access door blocking device for securing an access door of a mineral material crusher, comprising
a first block configured to block opening of the access door when moved from a first releasing position to a first blocking position; and
a second block configured to block opening of the first block when moved from a second releasing position to a second blocking position.

Advantageously, a second level of blocking is provided to prevent opening of the first block and secure the locking of an access door. The second block prevents the access to and use of the first block when in a second blocking positions. Further, chances for undesired opening the access door while the crusher is running are mitigated. Further, a possibility to enter inside the crusher while its parts are still moving is reduced.

The first block may be configured to remain coupled to the access door blocking device when moved to the first releasing position. This may mitigate the amount of wear and tear to the first block since the first block does not need to be removed and reinstalled when moving the first block between first blocking and releasing positions. Further, chances to lose parts of the first block may be reduced.

The first block may further be configured to induce an opening force to the access door on moving from the first blocking position to the first releasing position. This may assist in the opening access door, especially if the access door is particularly heavy or jammed.

The first block may further comprise a rotatably lockable member configured to move by rotating between the first releasing position and the first blocking position.

The rotatably lockable member may be threaded to releasably attach to a crusher body of a mineral material crusher.

The first block may further comprise a slidably lockable member configured to move by sliding between the first releasing position and the first blocking position.

The second block may be pivotably movable between the second releasing position and the second blocking position. Alternatively, the second block may be rotatably movable between the second releasing position and the second blocking position. Alternatively, the second block may be slidably movable between the second releasing position and the second blocking position.

The second block may further be pivotably connected to the door either directly or through the access door blocking device.

The second block may comprise an electric lock. The electric lock may be remotely controlled. The second block may further comprise a slidably lockable member configured to move by sliding between the second releasing position and the second blocking position. The second block may further comprise an interlock actuator.

The access door blocking device may further comprise a blocking body that is permanently fixable to or at least in part formed integrally with the access door.

The second block may be attached to the blocking body.

The first block may be configured to couple the blocking body with a crusher body of the mineral material crusher, when the first block is in the first blocking position.

The blocking body may further comprise a U-shaped plate structure configured to extend along the access door and beyond an edge of the access door onto a crusher body of the mineral material crusher when the access door is closed, such that the blocking body provides a coupling structure for the first block and a handle for opening the access door by a user.

The second block may be configured to remain attached to a crusher body of the mineral material crusher when the access door is opened or closed. Various movement types and attachment options of the first block and the second block provide design flexibility for designing and installing crushers and crusher access doors with blocking mechanisms.

The second block may further comprise a receptacle to block accessing and moving the first block by a user when the first block is in the first blocking position. Accordingly, the first block cannot be operated while the second block is in the second blocking position.

The access door blocking device may further comprise a detector configured to detect moving of the second block out of the second blocking position. In an example embodiment, the detector is configured to issue a releasing signal in response to the moving of the second block out of the second blocking position. In another example embodiment, the detector is configured to continuously or continually issue a status signal that enables the detection of the moving of the second block out of the second blocking position.

The access door blocking device may further comprise a remote controllable lock to either lock the first block in the first blocking position or to release the first block to be movable out of the first blocking position.

According to a second example aspect there is provided a mineral material crusher comprising the blocking device.

According to a third example aspect there is provided a mineral material crushing plant comprising the mineral material crusher of the second example aspect. The mineral material crushing plant may be a fixed mineral material crushing plant. Alternatively, the mineral material crushing plant may be a mobile mineral material crushing plant.

According to a fourth example aspect there is provided a method for securing an access door of a mineral material crusher, comprising:
blocking by a first block opening of the access door when moved from a first releasing position to a first blocking position; and
blocking by a second block opening of the first block when moved from a second releasing position to a second blocking position.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 schematically shows an access door of a mineral material crusher equipped with an access door blocking device according to an example embodiment;

FIG. 2 schematically shows a close-up view of an access door blocking device according to an example embodiment with the first block in a first blocking position and the second block in a second releasing position;

FIG. 3 schematically shows a cross-sectional side view of an access door blocking device according to an example embodiment with both first block and second block in a blocking position;

FIG. 4 shows a flow chart according to an example embodiment; and

FIG. 5 shows a schematic drawing of a mobile crusher plant according to an example embodiment.

### DETAILED DESCRIPTION

In the following description, like reference signs denote like elements or steps.

FIG. 1 schematically shows an access door of a mineral material crusher equipped with an access door blocking device according to an example embodiment. In the embodiment of FIG. 1, the access door 101 is attached to an access door frame on the mineral material crusher body 102 via a hinge mechanism 103, such that the access door 101 can be opened and closed. The access door 101 allows maintenance access to the crusher interior.

In an embodiment, the first block of the access door blocking device comprises a blocking body 111, a rotatably lockable member 112, and a counter-piece 113 for the rotatably lockable member 112 on the mineral material crusher body 102. In the embodiment of FIG. 1, the first block is in a first blocking configuration. The first block is configured to be movable between a first releasing position and a first blocking position. The first block is configured to allow opening of the access door when moved from a first blocking position to a first releasing position. In the first blocking position, the rotatably lockable member 112 is secured inside the counter piece 113. In the first releasing position, the rotatably lockable member 112 is released from the counter piece 113. In an embodiment, the first block is configured to induce an opening force to the access door on moving from the first blocking position to the first releasing position. The first block is configured to block opening of the access door when moved from a first releasing position to a first blocking position. In an embodiment, the access door blocking device comprises a remote controllable lock to either lock the first block in the first blocking position or to release the first block to be movable out of the first blocking position. Advantageously, the remote-controlled lock provides an additional level of security and control over opening the first block and the access door 101.

In an embodiment, the second block of the access door blocking device comprises an attachment member 121, a movable member 122 that houses a receptacle 201 for the rotatably movable locking member 112 of the first block, a second lockable member 123 attached onto the movable member 122, and a second counter piece 124 attached on the mineral material crusher body 102. In the embodiment of FIG. 1, the second block is in a second releasing configuration. The second block is configured to be movable between a second releasing position and a second blocking position. The second block is configured to allow opening of the first block when moved from a second block position to a second releasing position. The second block is configured to block opening of the first block when moved from a second releasing position to a second block position.

In an embodiment, the position of the hinges 103 and the opening direction of the access door 101 are varied. For example, the access door 101 can be hinged at the left or right-hand side of the door frame so as to be left or right-hand opening. In an example embodiment, the access door 101 is a sliding door. Compatibility of the blocking device with different door opening directions and attachment means enables design flexibility to the crusher construction and blocking device installation.

In an embodiment, a blocking body 111 is a U-shaped plate structure configured to extend along the access door 101 and beyond an edge of the access door 101 onto a crusher body 102 of the mineral material crusher when the access door 101 is closed, such that the blocking body 111 provides a coupling structure for the first block. In the embodiment of FIG. 1, the blocking body further provides a handle for opening the access door 101 by a user. The blocking body 111 aligns the rotatably lockable member 112 with the counter piece 113. In an embodiment, the blocking body 111 is configured to house the counter piece 113 protruding outwards from the mineral material crusher body 102 between the blocking body 111 and crusher body 102 when the access door 101 is closed. In an embodiment, the blocking body 111 is permanently fixable or fixed to or at least in part formed integrally with the access door 101. In an embodiment, an additional separate handle (not shown) is fixed to the blocking body 111. In a further embodiment, the separate handle is movable and configured to operate an additional safety latch (not shown) configured to prevent unintentional opening of the door. That is, after releasing the blocking device, still an additional turn of the handle is required to release a security latch and allow opening of the access door 101.

In an embodiment, the rotatably lockable member 112 is configured to move by rotating between a first releasing position and a first blocking position. In an alternative embodiment, first block comprises a slidably lockable member (not shown) configured to move by sliding between the first releasing position and the first blocking position. In an embodiment, a rotatably lockable member 112 is coupled to and extends through the blocking body 111, in a way that it can be freely rotated. In an embodiment, the rotatably lockable member 112 is a screw. In an embodiment, the rotatably lockable member 112 is a bolt. In an embodiment, the rotatably lockable member 112 comprises a handle, lever, or a wheel for tightening or loosening the rotatably lockable member 112. In an embodiment, when the first block is in a first blocking configuration, the rotatable lockable member is secured inside the counter piece 113 on the crusher body 102 to lock the access door 101. In an embodiment, the rotatably lockable member 112 is threaded so as to releasably attach to a crusher body 102 of the mineral material crusher. Likewise, in an embodiment, the counter piece 113 on the crusher body 102 is threaded in a compatible manner. In an embodiment, the rotatably lockable member 112 comprises a latch that is compatible with the counter piece 113 and rotatable between a releasing position and a blocking position by rotating the rotatably lockable member 112.

In an embodiment, the rotatably lockable member 112 is removable from the first block when the first block is in a releasing position. In an embodiment, the rotatably lockable member 112 is configured to remain coupled to the blocking body 111 when the first block is in a first releasing position. Advantageously, rotatably lockable member 112 remaining coupled to the blocking body 111 mitigates the possibility of losing the rotatably lockable member 112 when the access door 101 is opened.

A counter piece 113 is configured to match the shape of the rotatably locked member 112 to provide locking in the blocking position of a first block. In an embodiment, the counter piece 113 is threaded to match a threaded rotatably lockable member 112. In an embodiment, a counter piece 113 for the rotatably lockable member 112 protrudes outward from the crusher body 102. In an embodiment, the counter piece 113 extends into the crusher body 102. In an embodiment, the counter piece 113 is an integral part of the crusher body 102.

In the embodiment of FIG. 1, the attachment member 121 of a second block is attached to the blocking body 111 of the first block. In an embodiment, the attachment member 121 is attached to the access door 101. That is, the attachment member 121 attaches the second block to the access door 101 directly or through the blocking body 111. Therefore, the second block remains attached to the blocking body 111 and access door 101 when the door is opened or closed. In an alternative embodiment, the attachment member 121 is attached to the crusher body 102. Therefore, the second block is configured to remain attached to a crusher body 102 of the mineral material crusher when the access door 101 is opened or closed. In an embodiment, the attachment member 121 is releasably attached to the blocking body 111 or the crusher body 102. In an embodiment, the attachment member 121 provides an attachment point for a movable member 122 of the second block.

In an embodiment, the movable member 122 is movably coupled to the attachment member 121. In the embodiment of FIG. 1, the movable member 122 is pivotably coupled to the attachment member 121 by a hinge mechanism. The hinge allows moving of the second block between a second releasing position and a second blocking position. In an embodiment, the movable member 122 comprises a receptacle 201 configured to block accessing and moving the first block by a user when the first block is in the first blocking position and the second block is in the second blocking position. In the embodiment of FIG. 1, the movable member 122 comprises a receptacle 201 for the rotatably lockable member 112. In an alternative embodiment, the movable member 122 is pivotably coupled directly to the access door 101. In an alternative embodiment, the movable member 122 pivotably coupled directly to the first block. In an alternative embodiment, the movable member 122 pivotably coupled directly to the crusher body 102. In an alternative embodiment, the movable member 122 is slidably coupled to the access door 101. In an alternative embodiment, the movable member 122 is slidably coupled to the attachment member 121. In an alternative embodiment, the movable member 122 is slidably coupled to the first block. In an alternative embodiment, the movable member 122 is slidably coupled to the crusher body 102. In an alternative embodiment, the movable member 122 is rotatably coupled to the access door 101. In an alternative embodiment, the movable member 122 is rotatably coupled to the attachment member 121. In an alternative embodiment, the movable member 122 is rotatably coupled to the first block. In an alternative embodiment, the movable member 122 is rotatably coupled to the crusher body 102.

In the embodiment of FIG. 1, a second lockable member 123 is attached to a distal end of the pivotably coupled movable member 122. In an embodiment, the second lockable member 123 is an electric lock member. In an embodiment, the second lockable member 123 is an interlock actuator member. Detachment or release of an interlock actuator member from an interlock receptacle is configured to prevent machine operation or start up. In an embodiment, the second block comprises both the electric lock member and an interlock actuator member. In an embodiment, the second lockable member 123 is configured to function as both an electric lock member and an interlock actuator member. In an embodiment, a second lockable member 123 is movably attached to a movable member 122. In an embodiment, the second lockable member 123 is rotatably lockable. In an embodiment, the second lockable 123 member is a slidably lockable member configured to move by sliding between the second releasing position and the second blocking position. In an embodiment, the second lockable member 123 comprises both a lockable member and an interlock actuator.

In an embodiment, a second counter piece 124 is permanently attached to the crusher body 102. In an embodiment, the shape of a second counter piece is configured to match or complement the shape of a second lockable member 123 to allow locking of the second block in a second blocking configuration. In an embodiment, the second counter piece 124 is an electric lock receptacle configured to be coupled with the electric lock member 123. In an embodiment, the electric lock comprising the electric lock member 123 and the electric lock receptacle 124 is remotely controllable. In an embodiment, a second counter piece 124 is an interlock receptacle or a detector 124 configured to be coupled with the interlock actuator member of a second lockable member 123. In an embodiment, the second counter piece 124 is configured to function as both an electric lock receptacle and an interlock receptacle. In an embodiment, when a second block is moved from a second blocking configuration to a second releasing configuration, the interlock actuator is configured to be released from the interlock receptacle to generate a signal to stop and prevent the operation of a crusher. In an embodiment, the second counter piece 124 is a detector configured to detect the release of the second lockable member from the second counter piece 124. In an embodiment, the second counter piece detector 124 is configured to detect moving of the second block out of the second blocking configuration. For example, the second counter piece detector 124 can be configured to issue a releasing signal in response to the moving of the second block out of the second blocking configuration. Alternatively or additionally, the second counter piece detector 124 can be configured to issue a signal that enables detecting the moving of the second block out of the second blocking configuration.

Advantageously, halting of the crusher is commenced while a first block and an access door 101 are still closed. Therefore, the crusher has additional time to stop before the first block is released and the access door 101 opened. Accordingly, a chance for a person to open the access door 101 while the crusher parts are still moving is mitigated. For the sake of an example, if an access door 101 did not comprise a second block and the interlock actuator was coupled to a first block only, the interlock signal to halt the crusher would be generated at the same time when the first block and access door is opened. In such case, a person could potentially enter inside a crusher while its parts are still moving.

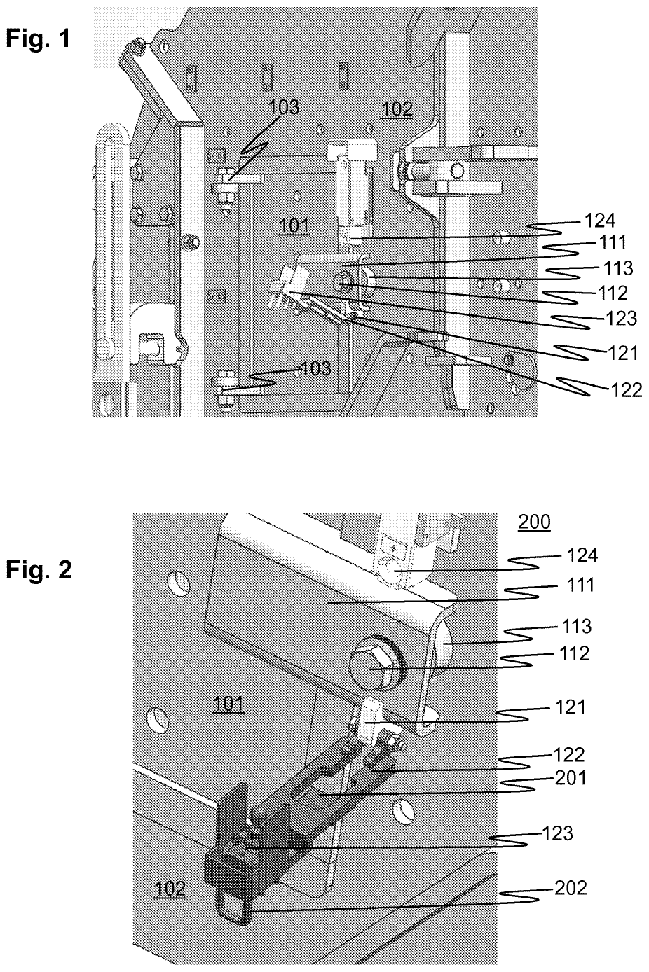

FIG. 2 schematically shows a close-up view of an access door blocking device 200 according to an example embodiment with the first block in a first blocking position and the second block in a second releasing position. In the embodiment of FIG. 1 and FIG. 2, a movable member 122 of a second block comprises a receptacle 201 for the rotatably lockable member 112 of a first block. In an embodiment, the receptacle 201 is configured to match the shape of the head of the screw or a bolt of the rotatably lockable member 112, when the second block is in a blocking position. In an embodiment, the receptacle 2021 is configured to match the shape of a movably lockable member 112 of a first block and prevent it from rotating by a physical contact when the second block is in a second blocking position. This prevents moving of the first block from a first blocking position to a first releasing position and secures the blocking of the access door 101. Therefore, the second block, when in a second blocking position, mitigates the chances of unintentional opening of the first block due to, for example, vibration from the crusher, a poorly tightened first block or a partially worn-out threads of the rotatably lockable member 112, by preventing the movement of the rotatably lockable member 112. In other words, the second block provides a second level of blocking by ensuring that the first block remains in a first blocking position and that the first block cannot be accidentally or unsafely opened. In an embodiment, the second block is secured in the second blocking position by an electric lock (123, 124).

In an embodiment, the receptacle 201 and the movable member 122 of the second block are configured to prevent access to and moving of the first block by a user during crusher operation when the first block is in the first blocking position (and the second block is in the second blocking position). That is, in the embodiment of FIGS. 1 and 2, the rotatably lockable member 112 becomes housed inside the movable member 122, when the second block is in a second blocking position. Thus, the second block must be opened first to have access to move the rotatably lockable member 112 of the first block. Accordingly, opening of an access door 101 is a two-step process. In an embodiment, a release of an interlock actuator 123 from an interlock receptacle 124 stops the crusher operation and prevents its use, when the second block is moved from the second blocking position to the second releasing position. Therefore, it is not possible to move the first block from a first blocking position to a first releasing position or open the access door 101 before the second block is released and/or while the crusher is running.

In order to avoid a chance of moving the second block to the second blocking position without blocking the first block, the second block is preferably attached to or formed as a part of the access door 101.

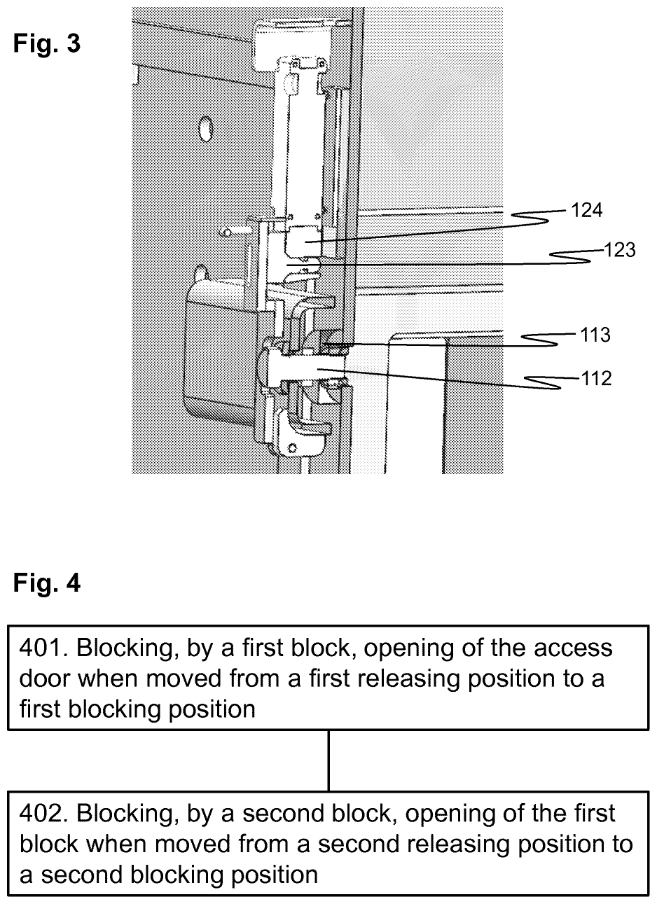

FIG. 3 schematically shows a cross-sectional side view of an access door blocking device according to an example embodiment with both first block and second block in a blocking position. There, the connection between the rotatably lockable member 112 and a first counter piece 113 of the first block and the connection between a second lockable member (e.g., an electric lock member or an interlock actuator) 123 and a second counter piece 124 (e.g., an electric lock receptacle, an interlock receptacle, or a detector) in blocking configuration is depicted. The second counter piece 124 may provide a locking with an actuator holding force of at least 9000 N, or at least 5000 N.

In an example embodiment, the second counter piece comprises a visual indicator configured to signal a current status of the second block. For example, the visual indicator comprises one or more LED lights or a display configured to show whether the second block is in the second blocking position and/or whether the second block is retained in the second blocking position by the second counter piece 124. In effect, the second lockable member 123 and the second counter piece 124 may form a third block that is electrically controllable to block moving the second block from the second blocking position to the second releasing position.

In an example embodiment, the second counter piece 124 or the second lockable member is configured to detect the forming of the third block by detecting a radio-frequency identification, RFID, tag or near field communication, NFC, tag in a proximity that indicates the forming of the third block. Advantageously, bypassing of the third block may be significantly hindered by preventing the user simply manipulating a switch or detector, when using an RFID or NFC detection.

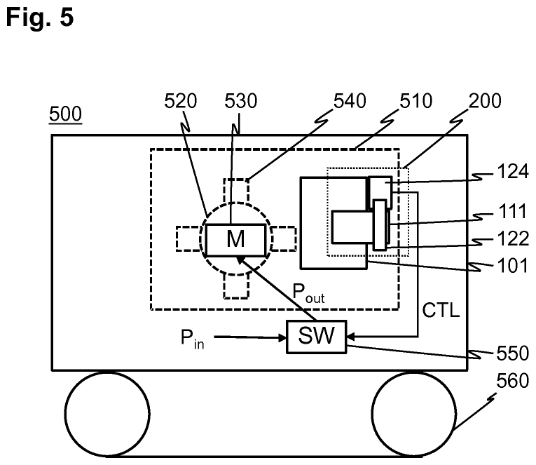

In an example embodiment, an access door securing system comprises the access door blocking device 200. The access door securing system may further comprise a controllable switch 550 shown in FIG. 5, such as a relay or contactor, which is configured to prevent driving of the mineral material crusher when the first and second blocks are not in their first and second blocking positions, respectively. In an example embodiment, the controllable switch is configured to prevent driving of the mineral material crusher when the third block is not blocking the moving of the second block from the second blocking position to the second releasing position.

FIG. 4 shows a flow chart according to an example embodiment. FIG. 4 illustrates a process for securing an access door of a mineral material crusher, comprising various possible steps including some optional steps while also further steps can be included and/or some of the steps can be performed more than once:

410. blocking, by a first block, opening of the access door when moved from a first releasing position to a first blocking position; and

420. blocking, by a second block, opening of the first block when moved from a second releasing position to a second blocking position.

To open the access door 101 from the blocked position to a fully released position, the above steps are reversed and performed in reverse order.

FIG. 5 shows a schematic drawing of a mobile crusher plant 500 according to an example embodiment. The mobile crusher plant 500 comprises the access door blocking device 200, a crushing chamber 510, the access door 101 controlled by the access door blocking device 200, a rotor shaft 520 that carries and drives a crushing rotor 540, the controllable switch 550, and in this case, a track base 560 for self-propelled movement. It is appreciated that in other example embodiments, various details differ. For example, the crusher plant 500 may not have the crushing rotor 540 but instead, the crusher plant 500 comprises rollers or other crushing elements. Likewise, the crusher plant 500 need not be mobile or the crusher plant may be self-propelling in another way than using tracks, e.g., wheel based, or the crusher plant may be towable with wheels, tracks, and/or skids.

As drawn in FIG. 5, the access door blocking device 200 may control the controllable switch to prevent driving of the rotor shaft 520 or other moving parts while the access door 101 is not secured in a closed position. In an example embodiment, an automation system (not drawn) controls the controllable switch and/or the third block. For example, the automation system may maintain the third block in a locking state to prevent moving the second block out of the second blocking position while rotor shaft 520 is rotating. The automation system may further prevent driving of the rotor shaft 520 while the second block is not in the second blocking position.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1-15. (canceled)

16. An access door blocking device for securing an access door of a mineral material crusher, comprising:
a first block configured to block opening of the access door when moved from a first releasing position to a first blocking position; and
a second block configured to block opening of the first block when moved from a second releasing position to a second blocking position,
wherein the second block comprises a receptacle to block accessing and moving the first block by a user when the second block is in the second blocking position.

17. The access door blocking device of claim 16, wherein the first block further comprises a rotatably lockable member configured to move by rotating between the first releasing position and the first blocking position.

18. The access door blocking device of claim 17, wherein the rotatably lockable member is threaded to releasably attach to a crusher body of the mineral material crusher.

19. The access door blocking device of claim 16, wherein the second block is pivotably movable between the second releasing position and the second blocking position.

20. The access door blocking device of claim 17, wherein the second block is pivotably movable between the second releasing position and the second blocking position.

21. The access door blocking device of claim 19, wherein the second block is pivotably connected to the access door either directly or through the access door blocking device.

22. The access door blocking device of claim 21, wherein the second block is pivotably connected to the access door either directly or through the access door blocking device.

23. The access door blocking device of claim 16, further comprising a blocking body that is permanently fixable to or at least in part formed integrally with the access door.

24. The access door blocking device of claim 17, further comprising a blocking body that is permanently fixable to or at least in part formed integrally with the access door.

25. The access door blocking device of claim 23, wherein the second block is attached to the blocking body.

26. The access door blocking device of claim 23, wherein the first block is further configured to couple the blocking body with a crusher body of the mineral material crusher, when the first block is in the first blocking position.

27. The access door blocking device of claim 24, wherein the first block is further configured to couple the blocking body with a crusher body of the mineral material crusher, when the first block is in the first blocking position.

28. The access door blocking device of claim 23, wherein the blocking body comprises a U-shaped plate structure configured to extend along the access door and beyond an edge of the access door onto a crusher body of the mineral material crusher when the access door is closed, such that the blocking body provides a coupling structure for the first block and a handle for opening the access door by a user.

29. The access door blocking device of claim 24, wherein the blocking body comprises a U-shaped plate structure configured to extend along the access door and beyond an edge of the access door onto a crusher body of the mineral material crusher when the access door is closed, such that the blocking body provides a coupling structure for the first block and a handle for opening the access door by a user.

30. The access door blocking device of claim 26, wherein the blocking body comprises a U-shaped plate structure configured to extend along the access door and beyond an edge of the access door onto a crusher body of the mineral material crusher when the access door is closed, such that the blocking body provides a coupling structure for the first block and a handle for opening the access door by a user.

31. The access door blocking device of claim 16, further comprising a detector configured to detect moving of the second block out of the second blocking configuration.

32. The access door blocking device of claim 16, further comprising a remote controllable lock to either lock the first block in the first blocking position or to release the first block to be movable out of the first blocking position.

33. The access door blocking device of claim 32, further comprising a remote controllable lock to either lock the first block in the first blocking position or to release the first block to be movable out of the first blocking position.

34. A mineral material crusher comprising the blocking device of claim 16.

35. A method for securing an access door of a mineral material crusher, comprising:
blocking by a first block opening of the access door when moved from a first releasing position to a first blocking position;
blocking by a second block opening of the first block when moved from a second releasing position to a second blocking position; and
blocking by a receptacle of the second block accessing and moving the first block by a user when the second block is in the second blocking position.
